(19) United States
(12) Patent Application Publication
(10) Pub. No.: US 2005/0177814 A1
(43) Pub. Date: Aug. 11, 2005

(54) System for providing a graphical representation of user interface and executable application operation

(76) Inventor: Aaron Emerson Martlage, Narberth, PA (US)

Correspondence Address: Siemens Corporation;Intellectual Property Department, 170 Wood Avenue South, Iselin, NJ, 08830, US

(21) Appl. No.: 11/038,398

(22) Filed: Jan. 20, 2005

Related U.S. Application Data
(60) Provisional application No. 60/539,198, filed on Jan. 26, 2004.

(51) Int. Cl. G06F 9/44; G06F 9/45

(52) U.S. Cl. 717/102; 717/114; 717/104; 717/155

(57) ABSTRACT

A system provides a graphical representation of user interface operation. The system comprises an item selector to enable a user to select an item from a plurality of different types of items for incorporation in a display image. The display image includes object items comprising a first item representing a first image window, a second item representing a second image window invoked from the first image window, a third item representing a user selectable display element present in the first image window, and a plurality of connection items used for representing a plurality of connection types between the object items. The system further includes a display generator for initiating display of an image comprising a graphical representation of user interface operation including items selected using the item selector, in response to user command.

### CROSS REFERENCE TO RELATED APPLICATIONS

This is a non-provisional application of provisional application Ser. No. 60/539,198 by Aaron Martlage filed Jan. 26, 2004.

### 1. FIELD OF THE INVENTION

The present invention relates to improved methods and systems for diagramming an information architecture for an enterprise software development.

### 2. BACKGROUND OF THE INVENTION

An undesirable byproduct of the current trend in software development is the problem of software usability disconnects. Usability disconnects occur as a consequence of departmentalizing the analysis and coding of an application. In order to create software under the restrictive timelines that markets demand, it is common to have a large software application developed piecemeal by a number of different development groups without the benefit of an overarching view of the workflow and structure of the application. This is detrimental to the development process because successful software development requires communication of a general information architecture (the users workflow and data structure of a system) from product analyst and user interface (UI) designers to developers and testers.

Currently, most forms of documenting and diagramming software are based on Unified Modeling Language (UML) methodologies. While UML analysis focuses on creating baseline object-oriented programming structures, user interface (UI) design is not addressed and software often lacks a coherent workflow relationship between objects. While UML is able to diagram granular elements of an application, it is limited in representing connections of these granular elements as well as usability and operational characteristics of UI images. As a result, the software lacks a single vision of object workflow relationships and software usability disconnects occur which leads to a finished product that may meet the technical requirements but fails usability tests.

What is needed, therefore, is a system and method that addresses the structural and workflow needs of a software application that connects and explains high-level workflow and structure without being encumbered by functional requirements.

### SUMMARY OF THE INVENTION

The present invention overcomes the above-noted and other deficiencies of the prior art by providing a system and method for enhancing enterprise software development by harmonizing the independent development of different parts of a software application. Specifically, the system and method provides a graphical (diagrammatic) representation of a single cohesive high-level view of the software information architecture by effectively integrating the granular elements which make up an enterprise software development. The high-level view comprises graphical (diagrammatic) representations of specific screen-to-screen relationships that determines the workflow and structure of the application.

A system of the invention includes an item selector for enabling a user to select an item from a plurality of different types of items for incorporation in a display image including, object items comprising a first item representing a first image window, a second item representing a second image window, a third item representing a user selectable display element present in said first or second image window, and a connection item used for representing a connection between said object items. The system of the invention further includes a display generator for initiating display of an image comprising a graphical representation of user interface operation including items selected using the item selector, in response to a user command.

### BRIEF DESCRIPTION OF THE DRAWINGS

Referring now to the drawings in which like reference numbers represent corresponding parts throughout, where:

FIG. 1 illustrates an analysis document tree for constructing the software information architecture of an enterprise software development, according to the prior art;

FIG. 2 illustrates an analysis document tree for constructing a software information architecture of an enterprise software development embodying the invention; and

FIG. 3 illustrates an exemplary “First level UI diagram”.

### DETAILED DESCRIPTION OF THE INVENTION

A system and method are provided that enhances the process of enterprise software development through the creation of system diagrams that depict the workflow and structure of user interface (UI) objects for software applications which describe the information architecture. The system diagrams show role workflows without being encumbered with functional requirements thereby facilitating comprehension of the software information architecture. The system diagrams also establish how the various workflows interact which harmonizes the independent development of different parts of a software application to create a concrete workflow throughout the application.

The system and method provide a number of advantages over prior art systems. One advantage is the ability to create a high-level information architecture that establishes workflow and structure based on user task analysis. The high-level information architecture combines the disparate workflows that correspond to the granular tasks and workflows which comprise a software development into a single high-level information architecture diagram. This capability is enabled through the use of a toolset that includes object and connector definitions which are used to construct a graphic depiction of the high-level information architecture of an enterprise software development. By virtue of creating a high-level IA diagram, software developers that are involved in separate aspects of the research and development lifecycle of an enterprise software development are provided with an appreciation for the more global view of the software application thereby furthering the competence of the individuals and software development groups.

The disclosed elements to be described herein may be comprised of hardware portions (e.g., discrete electronic circuitry), software portions (e.g., computer programming), or any combination thereof. The system according to the invention may be implemented on any suitable computer running an operating system such as UNIX, Windows NT, Windows 2000 or Windows XP. Obviously, as technology changes, other computers and/or operating systems may be preferable in the future. The system as disclosed herein can be implemented using commercially available development tools together with special plug-ins.

In one embodiment, the system is implemented as an adjunct to a commercially available two-dimensional graphical design tool, such as, for example, Visio™, manufactured by Microsoft Corporation, located in Redmond, Wash. While the general operation of a graphical design tool, such as Visio comprises the user software environment it is not part of the invention. The Visio tool represents a platform for customizing and enhancing the Visio command language with notation and extensions to the existing graphical environment thus allowing the graphical notations of the invention to be implemented. These extensions include an item selector for accessing and manipulating object and object connector information. It should be noted, however, that the system of the invention does not rely on pre-existing third party graphical design tools, such as Visio, to carry out its intended functionality. Instead, the system is preferably implemented as a standalone application providing capabilities to allow end users to access and manipulate object and object connector information.

Irrespective of whether the system of the invention is implemented as an adjunct to a commercially available two-dimensional graphical design tool, such as Visio, or as a standalone application, the invention can be implemented as control logic in software, firmware, hardware or any combination thereof. In an embodiment where the invention is implemented using software, the software may be stored as a computer program product and loaded into a computer system using a removable storage drive, a hard drive or interface. Alternatively, the computer program product may be downloaded to a computer system over a communication path. The control logic (software) when executed by one or more processors causes the processors to perform the functions of the invention as described herein. As used herein, a processor comprises any one or combination of, hardware, firmware, and/or software. A processor acts upon information by manipulating, analyzing, converting or transmitting information for use by an executable procedure or an information device, and/or by routing the information to an output device. An executable procedure as used herein is a segment of code (machine readable instruction), sub-routine, or other distinct section of code or portion of an executable application for performing one or more particular processes and may include performing operations on received input parameters (or in response to received input parameters) and provide resulting output parameters. As used herein, an application comprises code or machine readable instruction for implementing predetermined functions including those of an operating system, healthcare information system or other information processing system, for example, in response user command or input. As used herein workflow defines the interaction between a user and the UI screens of an application.

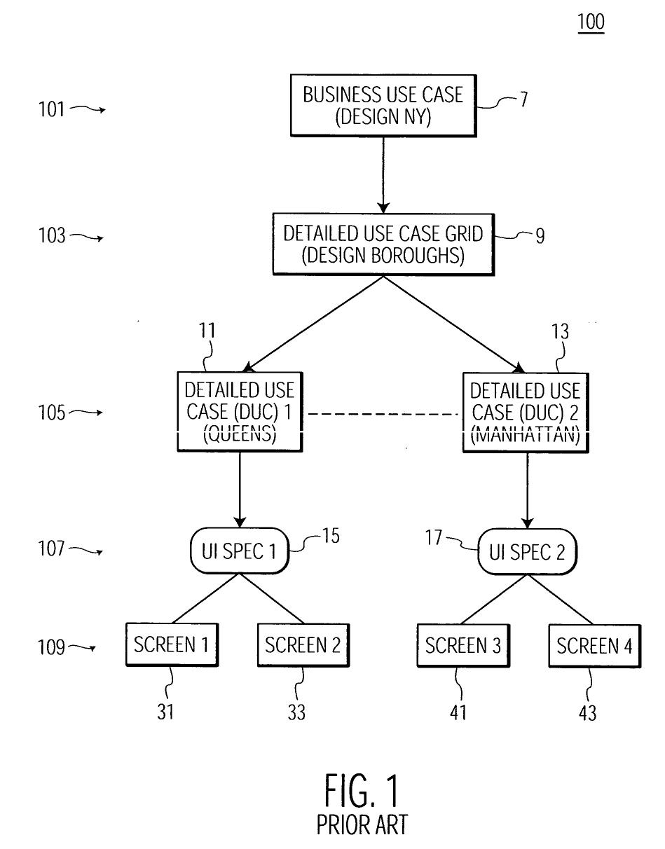

FIG. 1 illustrates a prior art process for constructing the software information architecture of an enterprise software development. Referring first to the top level 101 of an analysis document tree 100 there is shown a box entitled, “Business Use Cases” 7, which provides a high level job description of the enterprise software development.

The prior art process is described as follows in the context of an exemplary business use case 7 directed to the design of a major city like New York City.

At the next level 103 of the analysis document tree 100, there is shown the “Detailed Use Case Grid” 9 which describes, in summary form, the major workflows to be performed for the “Business Use Case” 7. For the illustrative example, the Detailed Use Case Grid 9 establishes five detailed use cases (i.e., workflows) pertaining to the different boroughs of New York, namely, Manhattan, Bronx, Brooklyn, Queens and Staten Island.

The “Detailed Use Case Grid” 9 at level 103 of the tree 100 is broken out at the next level 105 of the analysis document tree 100 into a number of detailed use cases corresponding one for one with the number of workflows described in “Detailed Use Case Grid” 9. The detailed use cases (DUCs) are documents that describe, in textual form, how the different workflows operate. In accordance with the instant example, five DUCs are generated corresponding to the five boroughs of New York. The respective DUCs describe the makeup of one of the five boroughs (e.g., population, roads, buildings and so on). For ease of explanation two DUCs are shown in FIG. 1. The first “Detailed Use Case 1” 11, could represent the design of the borough of Queens and the second “Detailed Use Case 2” 13, could represent the design of the borough of Manhattan.

The detailed use cases (DUC) have a corresponding UI specification (UI SPEC), shown at the next level 107 of the analysis document tree 100. In FIG. 1, for the workflow described by “DUC 1” 11, the corresponding UI specification is shown as “UI SPEC 1” 15. For the workflow described by “DUC 2” 13, the corresponding UI specification is shown as “UI SPEC 2” 17.

The UI specifications elaborate on their corresponding detailed use cases. In the present example, the UI SPECS describe a map of the borough described in the DUC including landmarks, buildings and streets and what those elements look like within the realm of the borough.

Moving further down the analysis document tree 100, it is further shown that the UI specifications 15, 17 are associated with one or more design screens. Specifically, “UI spec 1” 15 is associated with two design screens, 31 and 33 and UI spec 2” 17 is associated with two design screens, 41 and 43. It is noted the number of design screens that are associated with a particular UI specification depends upon the particular implementation. In the present example, the various design screens represent the layout of the borough including, for example, pictures of the streets and buildings.

To further illustrate the correspondence between DUCs and UI specifications, the DUC may, for example, recite the fact that avenues and streets run perpendicular to one another in the borough of Manhattan. It may additionally recite the fact that the avenues carry more traffic than the streets. These facts, recited in document form in the DUC, are then reflected in the UI specification's “picture” of the borough. For example, the UI picture might show the avenue being comprised of four lanes while the streets are comprised of two lanes.

In accordance with this exemplary prior art approach, at the end of the process for constructing a software information architecture of an enterprise software development, the delivered product consists of the detailed use case documents, e.g., “DUC 1” 11 and “DUC 2” 13 and their corresponding UI specifications, e.g., “UI SPEC 1” 15 and “UI SPEC 2” 17.

While the prior art process, described above, for doing requirements gathering and product analysis, as illustrated in FIG. 1, works well moving forward and is linear (top to bottom), one drawback is the lack of comprehension regarding the interrelationship of the various UI SPECS and their corresponding design screens. For example, it is difficult to understand from the various UI SPECS and their associated design screens how a function “A” defined in one UI SPEC relates to a function “B” defined in a different UI SPEC. What is created, in essence, are siloed solutions (a UI Spec and its design screens) without describing how the various siloed solutions integrate into the overall system.

It should also be appreciated that extrapolating the simple example described above and illustrated in FIG. 1 to a more sophisticated real world example including many more UI specifications along with their associated design screens significantly compounds the problem of comprehending the interrelationship of the UI specifications and their design screens.

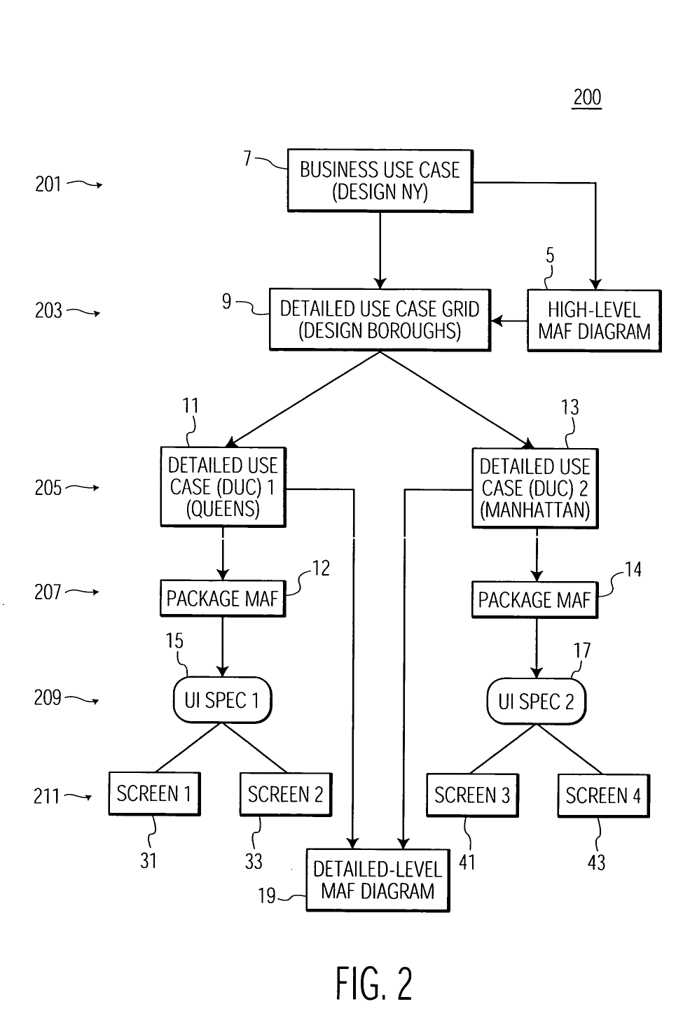

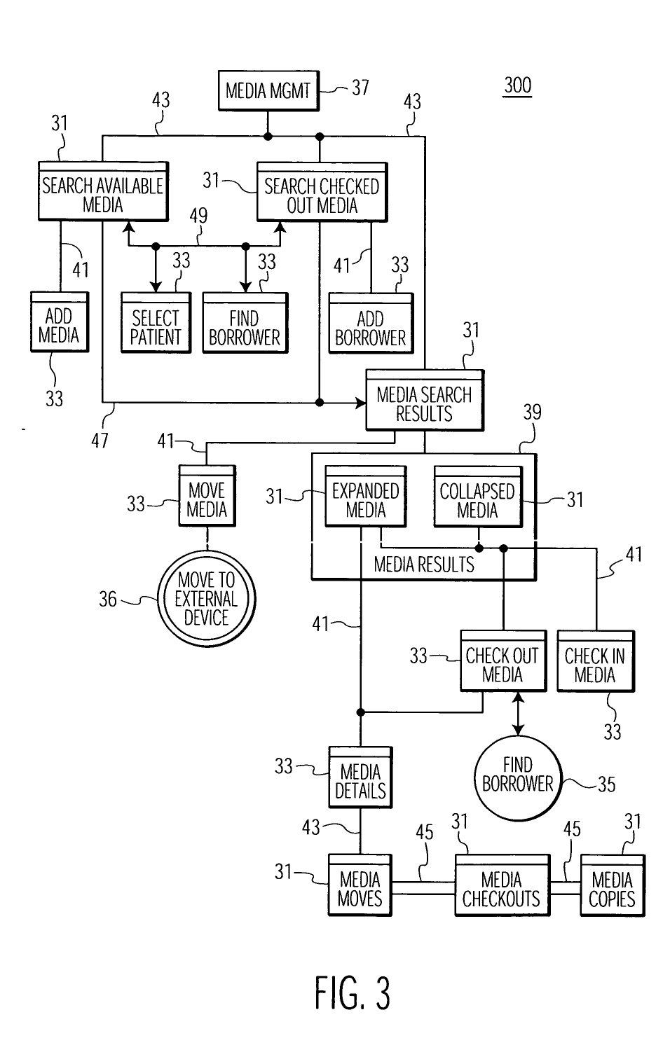

The present invention overcomes the limitations of the prior art by providing a graphical (diagrammatic) representation of a high-level view of the software information architecture that harmonizes the independent development of different parts of a software application (i.e., the siloed solutions) to create a concrete workflow throughout the application. The invention is described as follows with reference to FIGS. 2 and 3.

FIG. 2 illustrates an exemplary analysis document tree 200 for constructing a software information architecture of an enterprise software development. Notable differences between the analysis document trees of FIG. 1 and FIG. 2 are the inclusion of a high-level UI diagram 5, first level UI diagrams 12, 14 and a detailed level UI diagram 19. It is noted that the manner in which the various UI diagrams are constructed from their respective DUCs and UI specs is provided by way of example. Different applications may choose to construct the various UI diagrams using any number of proprietary or non-proprietary techniques. Irrespective of how the UI diagrams are created, the system utilizes the UI diagrams to create of a graphical representation which integrates the disparate workflows into a cohesive high level view of a software information architecture.

With reference to FIG. 2, the “High-level UI diagram” 5, shown on the right hand side of the diagram at level 203, is shown coupled to both the “Business Use Case” 7, at the higher level 201, and the “Detailed Use Case Grid” 9, at the same level 203. The “Business Use Case” 7 and the “Detailed Use Case Grid” 9 serve the same functions as previously described above with reference to FIG. 1 and will not be further described. The “High-level UI diagram” 5 is created from the “Business Use Case” 7 and provides a general idea of how to structure the overall integration of an enterprise software development project. It provides a rough layout of the software information architecture of an enterprise software development, determining, for example, where things are to be accessed from.

The “Business Use” case 7 in combination with the high-level UI diagram 5, help to generate the “Detailed Use Case Grid” 9 which is used together with the “High level UI diagram” 5 to determine what detailed use cases (DUCS) need to be written. In the instant example, two detailed use cases (DUCS) 11, 13 are required to be written and are shown at level 205.

As an example of how the DUCs are generated, consider, for example, an application directed to media management. The “Business Use Case” 7 describes the various functions performed by a media manager, such as, for example, keeping track of media (e.g., tapes, DVDs), re-stocking media at periodic intervals, evaluating media storage vendor products and so on. The “High level UI diagram” describes the media manager's workflow at a high level without including specific details. The DUCs are derived from both the “Business Use Case” 7 and “High level UI diagram” where each DUC describes how the media manager performs a particular function. That is, each DUC breaks down a function into its component parts. The “High level UI diagram” makes the DUCs more specific by preventing the creation of siloed solutions. In other words, the “High level UI diagram” is used to make the DUCs more specific by including a description of how the function details integrate with the other functions to be performed by the media manager.

It is noted that the “High-level UI diagram” 5 also helps to make the individual DUCS 11, 13 more specific. So, instead of noting in the “Detailed Use Case Grid” 9 that a task or workflow is to be performed, the “High-level UI diagram” 5 describes how that task relates to the rest of the software. As such, it provides a more focused approach. In the present example, the “High-level UI diagram” 5 may depict how the various boroughs of New York fit together at a high level. For example, a diagram of the boroughs might be created depicting the interrelationship of the boroughs (e.g., Queens is connected to Brooklyn, Manhattan separated from other boroughs by a body of water). A generalized picture is formed of the interrelationships in the “High-level UI diagram” 5.

The DUCS 11, 13 are written to describe in great detail the general workflows defined by the “Detailed Use Case Grid” 9. In the example, DUCS 11, 13 describe the boroughs in great detail.

At level 207, two “First level UIs” 12, 14 are shown. First level UI 12 corresponds to (DUC 1) 11 and first level UI 14 corresponds to (DUC 2) 13. Using the detailed information provided in its respective DUC, the first level U's 12, 14 represent the information architecture and collectively make up an enterprise software development. Specifically, they describe how to structure the workflow in software of a large software application. In the instant example, for a particular first level UI, the detailed steps described in its corresponding DUC could be carried out in one screen or a multiplicity of screens where the individual screens include the various object and connector types defined by the invention. Accordingly, the first level UIs define the structure of various portions of the workflow in software.

At level 209, the UI Specifications serve the same function as described above and will not be further described.

As shown in FIG. 2, the first level UIs 12, 14 are combined into a single “Detailed level UI diagram” 19 which provides a link for understanding how functions from one UI SPEC and their related screens relate to functions from the other UI SPECS and their related screens. The detailed level UI diagram 19 effectively integrates the granular elements (i.e., the first level UIs 12, 14) into a single cohesive high-level view of the software information architecture. The high-level view comprises graphical representations of specific screen-to-screen relationships that determines the workflow and structure of the application, as will be further illustrated in FIG. 3.

The detailed level UI diagram 19 connects the streets and avenues of Manhattan, as defined in first level UI 14 with the streets and avenues of Queens, in first level UI 12. Detailed level UI diagram 19 outlines bridges, ferries and other routes that allow a tourist to go from one borough to the next (e.g., Manhattan to Queens) including which streets to traverse and further including observational points of interest including buildings and landmarks.

FIG. 3 illustrates an exemplary first level UI diagram 300. The first level UI diagram 300 represents, at one level, a single cohesive high-level view of some number of first level UIs, such as the first level UIs 12, 14 shown in FIG. 2.

At the highest level view of a software information architecture, the constructed first level UI diagrams (e.g., UIs 12, 14) are consolidated into a single cohesive high-level diagram (i.e., a detailed level UI diagram (not shown)) which represents a map of the entire enterprise software application and how a user interacts with it. Advantageously, the detailed level UI diagram represents a way to combine multiple workflows into a single diagram to make the entire application understandable in a single cohesive high-level view. For example, it aids in the understanding of how functions from one UI SPEC relate to functions from another UI SPEC. It should be understood, however, that the first level UI diagram 300 of FIG. 3, and the detailed level UI diagram, are not intended to inform a user as to how the user interface (UI) should be presented, instead, the purpose is to utilize the diagrams to highlight workflow and structure. This is exemplified in the first level UI diagram 300 of FIG. 3 which describes a single cohesive high-level view of workflow and structure (i.e., the routes, thoroughfares, and various methods for traversing from a starting point in one borough to a destination point in another borough).

While definitions of the various object and connector types are provided throughout the description of FIG. 3 to follow, a more formal definition of the object and connector type is provided below in Appendix A.

FIG. 3 is an illustration of an exemplary first level UI diagram 300 including the various object and connector types of the invention. The exemplary diagram is provided in the context of a software architecture directed to media management As described above, the system of the invention may be implemented as an adjunct to a commercially available two-dimensional graphical design tool, such as Visio, or as a standalone application.

The explanation of the first level UI diagram 300 to follow is organized as a description of object types followed by a description of connector types.

Object Types

Object types include screen objects, dialog objects, component objects, hop objects and group objects.

Referring now to FIG. 3, a screen object, “Media Mgmt” 37 is shown at the top of the first level UI AF diagram 300. The “Media Mgmt” 37 screen object resides at the top of the hierarchy of objects and represents the first screen that a user sees when interacting with a software application. One characteristic of a screen object is that it may have children but it rarely exists as the child of another object. The “Media Mgmt” 37 screen object is shown connected to three children (component objects), a “Search Available Media” 31 component object, a “Search Checked Out Media” 31 component object and a “Media Search Results” 31 component object. A component object is one of the basic object types and represents a UI element of the user interface wholly contained within a screen, dialog or another component. For example, the three component objects 31 shown are wholly contained within the “Media Mgmt” 37 screen object.

The component object is versatile in the type of UI element it can represent. For example, a component object can represent, without limitation, an area of the screen, a drop down, or a button. A component object is typically used in a first level and/or detailed level UI diagram to define a UI element to (a) alter the user's workflow in some way or (b) changing the structure of the application. A filter is one example of an element that does “not” alter the workflow in some way and as such cannot be represented by a component object. A filter reduces an initial set of results (e.g., 100) to a smaller number of filtered results (e.g., 20) with no alteration of workflow in the process.

Another object type illustrated in the first level UI diagram 300 of FIG. 3 is the dialog object, sometimes referred to as a “pop up window” because dialog objects appear as a self contained screen “on top” of the parent object which invokes the dialog object. In other words, a dialog object represents a new window invoked from a prior window that co-exists with the prior window. As such, dialog objects cannot exist without a parent object which could be, for example, a screen object, component object or other dialog object. FIG. 3 shows the “Add Media” 33 dialog object, located in the upper left hand portion of the diagram 300. The “Add Media” 33 object represents a self contained screen invoked from the “Search Available Media” 31 component object.

The first level UI diagram 300 illustrates the use of a hop object 35. Hop objects implies. These objects aid in the authoring and reading of first level and/or detailed level UI diagrams, such as first level UI diagram 300. They aid in the authoring and reading of first level and/or detailed level UI diagrams in two ways. The hop object serves two purposes. First, it can show a transition from one part of a first level and/or detailed level UI diagram to another part via an interaction connector where an interaction connector represents a user action within a UI image window to open a dialogue or select an option within the UI image window.

FIG. 3 shows a hop object 35 located in the lower right hand portion, drawn as a “caret” on a circle which points in the general direction of a target object. In the example, the hop object 35 represents a virtual link to the “Find Borrower” dialog object 33 (target object) residing in a different location in the system diagram.

The second intended purpose served by the hop object 35 is to show that one or more objects (UI elements) reside in two locations within a system diagram. This may be shown using an integration connector coupled to a hop object. It is noted that this purpose is not illustrated in the diagram 300 of FIG. 3. An integration connector represents a process of collapsing or absorbing whatever the hop object is pointing to. Integration connectors inform the user to follow the link. By way of analogy, the hop object's second intended purpose can be analogized to a shortcut icon in Windows, typically located on a user's desktop and used to expediently launch an application. The shortcut icon facilitates opening up an application from a different location without requiring the user to look for the real launch point.

Another object type defined herein is the group object which is a UI element for referencing objects jointly. That is, certain objects may be grouped together because no one object in the group takes precedence over another. The objects which comprise or make up a group object represent equivalent alternatives.

In the illustrative example, group object 39 includes two constituent component objects, the “Expanded Media” 31 component object and the “Collapsed Media” 31 component object, representing equivalent alternatives.

Connector Types

In addition to the various objects described above, FIG. 3 also illustrates a number of connector types which connect the various objects in a manner to be described. The connector types include: a 2-way, an interaction connector, an integration connector, a sibling connector and a workflow connector.

An interaction connector 41 is shown connecting the “Search Available Media” 31 component object to the “Add Media” dialog object. Interaction connectors are used to indicate a user clicking a UI element within an image window to open a dialog or select an option within a UI element such as a drop down list (represented by a component) that affects a workflow or structure.

A two-way (bi-directional) type of interaction connector 49 is shown in the top portion of the first level UI 300 of FIG. 3 connecting two component objects, namely, the “Search Available Media” 31 component object and the “Search Checked Out Media” 31 component object to three dialog objects 33, namely, the “Select Patient”, “Find Borrower” and “Add Borrower” dialog objects 33. It should be understood that two-way interaction connectors affect the parent objects (e.g., the component objects).

An integration connector 43 is shown in the top portion of the first level UI diagram 300 of FIG. 3 connecting three component objects, namely, the “Search Available Media” 31 component object, the “Search Checked Out Media” 31 component object and the “Media Search Results” 31 component object to the connecting The “Media Mgmt” 37 screen object. An integration connector 43 is used to connect a child component to a parent screen, dialog or component. The integration connector 43 is a representation that the parent object contains the child object. Utilizing the integration connection 43 allows a user to “zoom in” on a specific parent object (e.g., Media Mgmt 37 screen object) to view how that object is broken down further. It's more of an exploding of the object instead of a zoom in.

Another exemplary use of an integration connector 43 is shown in the lower right hand portion of the diagram 300 of FIG. 3 connecting the “Media Details” 33 dialog object a child object, namely, the “Media Moves” 31 component object. The integration connector 43 illustrates that the three objects (media moves, media Checkouts, Media Copies) 45 are child components (e.g., tabs) wholly contained within the “Media Details” parent screen.

It is noted that the “Media Checkouts” 31 dialog object and “Media Copies” 31 component objects are connected to the “Media Moves” 31 component object via another connector type, referred to herein as a sibling connector 45. In the illustrative example, the sibling connector could illustrate that the “Media Details” 33 dialog object has three tabs associated with it, represented as component objects 31 and labeled, Media Moves”, “Media Checkouts” and “Media Copies”, respectively.

Another connector type illustrated in FIG. 3 is the workflow connector 47, one of which is shown connecting the “Search Available Media component object 31 to the “Media Search Results” 31 component object. A workflow connector is used to indicate that by interacting with a screen, dialog or component, a child object connected by a workflow connector is altered in some way without the user consciously changing the workflow.

Another connector type illustrated in FIG. 3 is the external hop 36, one of which is shown connected to the “Move to External Device” dialog object 33. An external hop is a hop to an external diagram or system. It can act as both an entry and an exit point. It is distinguishable from the hop object 35 shown in the lower right hand corner of FIG. 3 and described above in that the external hop does not include a “caret” symbol on a circle because the target object is not able to be referenced in the same diagram as the external hop 36.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

### APPENDIX A

Screen Objects

A screen object is a UI element that typically lives at the top of the hierarchy of objects within a Detailed level UI diagram. A screen object may have children but does not exist as the child of another object. A screen object may be used as a referenced object where multiple screens reside in a group. A screen object may or may not indicate a UI element that uses a computer monitor's available real estate. A screen typically represents either a large change in the workflow where a significant portion of the screen has changed and it benefits the diagram to use a screen or that it is the first object a user sees.

Dialog Object

A dialog object is a commonly used UI element that represents a new window invoked from a prior window that co-exists with the prior window as a self-contained screen (e.g., a pop-up window). By definition, dialog objects exist without a parent object (e.g., screen objects or components or other dialogs). A dialog object is used as a child object below a screen object or another dialog object. A dialog object appears “on top” of the parent object which invokes the object.

Component Object

A component object represents an element of the user interface wholly contained within a screen, dialog or another component. A component object is used as the child of another object and cannot exist without a parent object. The component object is versatile in the type of UI element it may represent. For example, a component object may represent an area of the screen, a drop down, a button, or any other UI element affecting workflow. A component object is used in a Detailed level UI diagram to define a UI element when by using the element, the user's workflow is altered in some way or using the element changes the structure of the application.

Hop Object

The hop object does not represent an actual UI element, rather it aids in the authoring and reading of a detailed level UI diagram. The hop is a shortcut as its name implies which serves two purposes: (1) to show a transition from one part of a Detailed level UI diagram to another part via an interaction of some type (a hop connected with an interaction connection), or (2) to illustrate that an object(s) located at another place within the system diagram is actually a UI element where the hop resides as well (a hop connected with an integration connection). In other words, a hop connected with an integration connection is a link to a different location in the system diagram. As shown in FIG. 3, the hop is drawn as a “caret” on a circle which points in the general direction of a target object. Within a drawing application, e.g., Visio, the hop may be selected with a green line connecting the hop and its target.

Group Object

A group object is a UI element for referencing objects jointly. Certain objects may be grouped together because no one object in the group takes precedence over another. In short, the objects in the group represent equivalent alternatives.

2-way Connector

A 2-way connector represents the bi-directional flow of data between a parent screen or component and a child dialog. The 2-way connector indicates that from the parent screen the dialog may be invoked and by interacting with the dialog, the structure or, more likely, the workflow of the parent screen is altered. When a 2-way connector is used in a UI diagram, it is typically a one-to-one relationship (e.g., screen-to-dialog or component-to-dialog).

Interaction Connector

The interaction connector represents a user clicking or invoking an action within a UI image window. An interaction is commonly used to indicate a user clicking a button within a UI image window to open a dialog or selecting an option within a UI element such as a drop down list (represented by a component) that affects a workflow or structure.

Integration Connector

The integration connector is commonly used to connect a child component to a parent screen, dialog or component. The integration connector is a representation that the parent object contains the child object. Utilizing the integration connection allows a user to “zoom in” on a specific parent object to view how that object is broken down further.

Sibling Connector

A sibling connector is used to indicate mutually exclusive options within a UI image window which are available within the same space where there is a default option upon initialization. A common usage of the sibling connector is to illustrate “tabs” where there is a default tab shown as a component of a screen and other “tabs” are linked horizontally to the default component with sibling connectors.

Workflow Connector

A workflow connector is used to indicate that by interacting with a screen, dialog or component, a child object connected by a workflow connector is altered in some way without the user consciously changing the workflow.

Filter Modifier

A filter modifier is used when an object is shown to filter a workflow or structure of child objects. It is commonly used in conjunction with a workflow connector illustrating that an object (typically a component) modifies an area of the screen (typically another component). Both components are typically children of the parent object as they both exist concurrently. However, a workflow between the objects is such that the filter object is hierarchically more important than, or affects, the child object of the workflow connector.

The objects (screen, dialog, component) also have properties associated them. These properties extend the diagram methodology in a way that is exclusively made available in an electronic form. The following is a description of the additional properties associated with a UI diagram.

Properties (Description, Role, Project)

The objects have a “description” property which is the addition of textual information that helps describe the object. The objects also have a “Role” property. For example, a medication administration screen may be made available exclusively to a nurse role while a patient record screen may be available to both a nurse role and a physician role. The objects are assigned a unique ID by Visio upon creation, in one embodiment. This ID cannot be changed by the author and is unique within a single diagram. However, IDs may be re-used across multiple diagrams. The screens, dialogs, and components have “iterations” which properly enable authors to state when multiple versions of data or scenarios for screens illustrate the various states of the object. For example, a screen may have three different data instances associated with a particular object which appear depending upon the workflow. In the diagram, we do not want three versions of the same object, so we create one object and list the various data iterations as a property of the single object.

Another property associated with a UI diagram created using the Visio stencil and template is “Project”. In certain cases it may be beneficial to describe the product derivation for a specific object. Often, diagrams can grow in complexity and it may be necessary to indicate the origin of the object or if the object is used in multiple projects. Another property associated with a UI diagram created using the Visio stencil and template is that Hops have a “Target”. The target should describe the target object of the hop as well as any descriptions of the situation surrounding the usage of the hop.

1. A system for providing a graphical representation of user interface operation, the system comprising:
an item selector for enabling a user to select an item from a plurality of different types of items for incorporation in a display image including,
object items comprising,
a first item representing a first image window,
a second item representing a second image window invoked from said first image window,
a third item representing a user selectable display element present in said first image window, and
a plurality of connection items used for representing a plurality of connection types between said object items; and
a display generator for initiating display of an image comprising a graphical representation of user interface operation including items selected using said item selector, in response to user command.

2. A system according to claim 1, wherein
said different types of items include an item identifier identifying the type of an individual item, said item identifier being included together with a corresponding selected item in said graphical representation of user interface operation.

3. A system according to claim 1, wherein
said connection item represents a two-way connector representing bi-directional data flow between said first image window and said second image window.

4. A system according to claim 1, wherein the connection item is a two-way connector representing a bi-directional flow between one of a parent screen or a component object and a child dialog,

5. A system according to claim 1, wherein the connection item is an interaction connector representing a user invoked action within a UI image window affecting workflow.

6. A system according to claim 1, wherein
said connection item represents at least one of, (a) user initiation of an action by activating said display element and connection to a resulting image window and (b) an indication a child object item is related to a parent object item.

7. A system according to claim 1, wherein
said connection item is between a hierarchically associated parent object item and a child object item and said child object is altered as a result of user interaction with said parent object item or said child object item.

8. A system according to claim 5, wherein
said connection item indicates said child object is altered by altering a task sequence to be performed by a user.

9. A system according to claim 1, wherein the connection item is a workflow connector representing an interaction with one of a screen object, a dialog object or a component object and further represents that said child object is altered by altering a task sequence to be performed by a user.

10. A system according to claim 1, wherein
said connection item indicates at least one of, (a) alternative and (b) mutually exclusive user selectable display elements.

11. A system according to claim 1, wherein the connection item is a sibling connector representing mutually exclusive options within a UI image window.

12. A system according to claim 1, wherein
said connection item indicates a parent object item alters a hierarchically associated child object item by at least one of, (a) altering a task sequence associated with said child object item and (b) altering an image area comprising said child object item.

13. A system according to claim 1, wherein the connection item is an integration connector representing a connection between a child component and one of a parent screen, a dialog object or a component object.

14. A system according to claim 1, wherein
said object items include a transition item indicating at least one of, (a) a transition of operation to a target object within another part of said graphical item and (b) said transition item is associated with a target object within said graphical representation of user interface operation.

15. A system according to claim 9, wherein
said target object is associated with at least one of, (a) a text description of said target object and (b) a description of characteristics identifying usage of said transition item.

16. A system according to claim 1, wherein the object item is a hop object representing a transition from one part of said display image to another part of said display image window.

17. A system according to claim 1, wherein the object item is a hop object representing at least one object located in a part of the display image is different from the location of the hop object is a user interface element.

18. A system according to claim 1, wherein
said object items include a group item indicating at least one object accessed in response to a user action and independently of a particular task sequence.

19. A system according to claim 1, wherein the object item represents multiple screen or component objects which cannot be viewed at the same time by a user.

20. A system according to claim 1, wherein the object item is a screen object representing a first image window that a user sees when interacting with a software application.

21. A system according to claim 1, wherein the object item is a screen object representing a change in workflow resulting in a change to a substantial portion of a display screen.

22. A system according to claim 1, wherein the object item is a dialog object representing a self-contained UI image window invoked from a prior invoked image window.

23. A system according to claim 1, wherein the object item is a component object representing a UI image window contained within one of a screen object, a dialog object or a component object.

24. A system according to claim 1, wherein an object item is associated with at least one of,
(a) an object identifier uniquely identifying an individual object,
(b) an object text description,
(c) a worker role determining whether said worker is able to access a particular object item,
(d) a product and
(e) a plurality of individually selectable and displayable data sets.

25. A system according to claim 1, wherein
said second image window is a pop-up menu hierarchically associated with, and initiated from, said first image window.

26. A system according to claim 1, wherein in response to user selection of a displayed object item in said image comprising a graphical representation of user interface operation, at least one of the following actions occur
(a) execution of an executable procedure associated with the displayed object item is initiated,
(b) display of an image presenting said selected display object is initiated,
(c) display of an image showing executable code associated with the displayed object item is initiated and
(d) testing of an executable procedure associated with the displayed object item is initiated.

27. A system according to claim 1, wherein
in response to user selection of a displayed connection item in said image comprising a graphical representation of user interface operation, at least one of the following actions occurs, (a) display of an image showing data exchanged between objects associated with the connection item is initiated, (b) elements of said graphical representation are highlighted indicating a task sequence and (c) elements of said graphical representation are sequentially highlighted indicating a task sequence.

28. A system for providing a graphical representation of user interface operation, comprising:
a display generator for initiating display of an image comprising a graphical representation of user interface operation including,
object items comprising,
a first item representing a first image window,
a second item representing a second image window,
a third item representing a user selectable display element present in said first image window, and
a connection item used for representing a connection between said object items.

29. A system for providing a graphical representation of user interface operation, comprising:
a display generator for initiating display of an image comprising a graphical representation of user interface operation including,
object items comprising,
a first item representing a first image window,
a second item representing a second image window,
a third item representing a user selectable display element present in said first image window, and
connection items used for,
indicating a sequence of commands associated with said objects,
an image navigation sequence associated with said objects and
data flows associated with said objects.

30. A system for providing a diagrammatic representation of a user interface operation, the system comprising:
an item selector for enabling a user to select an item from a plurality of user interface (UI) items for incorporation into a display image displaying the diagrammatic representation of the high-level view of the software information architecture; and
a display generator for initiating display of an image comprising a graphical representation of the high-level view of the software information architecture, in response to user command.

31. A system according to claim 30, wherein the plurality of UI items comprise UI objects and UI connectors for connecting said UI objects.

32. A system according to claim 31, wherein the UI objects comprise:
a screen object representing at least a portion of a UI image window;
a dialog object representing a self-contained UI image window invoked from a prior invoked window;
a component object representing an element of a UI image window contained within one of said screen object, said dialog object or a different component object;
a hop object representing a transition from one part of said display image to another part of said display image window, said hop object further representing that at least one object located in part of the display image different from the location of the hop object is a user interface element; and
a group object representing multiple screen or component objects which cannot be viewed at the same time by the user.

33. A system according to claim 31, wherein the UI connectors comprise:
a two-way connector representing a bi-directional flow between one of a parent screen or component and a child dialog;
an interaction connector representing the user invoking an action within a UI image window;
an integration connector representing a connection between a child component and one of a parent screen, dialog object or component object;
a sibling connector representing mutually exclusive options within a UI image window; and
a workflow connector for indicating that by interacting with one of a screen object, dialog object or component object a child object is altered without the user consciously changing the workflow.

34. A computer implemented apparatus for providing a diagrammatic representation f a software information architecture, the apparatus comprising:
a processor;
a memory connected to the processor and storing computer executable instructions therein;
wherein the processor, in response to execution of the instructions:
displays an item selector in a graphical user interface (GUI) display to enable a user to select an item from a plurality of different types of items for incorporation in a display image including,
object items comprising,
a first item representing a first image window,
a second item representing a second image window invoked from said first image window,
a third item representing a user selectable display element present in said first image window, and
a plurality of connection items used for representing a plurality of connection types between said object items; and
initiates a display generator to initiate a display of an image comprising a graphical representation of user interface operation including items selected using said item selector, in response to user command.

35. An article of manufacture for recommending items, comprising: a computer readable medium having computer readable code means embodied thereon, said computer readable program code means comprising:
an act of displaying an item selector in a graphical user interface (GUI) display to enable a user to select an item from a plurality of different types of items for incorporation in a display image including,
object items comprising,
a first item representing a first image window,
a second item representing a second image window invoked from said first image window,
a third item representing a user selectable display element present in said first image window, and
a plurality of connection items used for representing a plurality of connection types between said object items; and
an act of initiating a display generator to initiate a display of an image comprising a graphical representation of user interface operation including items selected using said item selector, in response to user command.
